(19) United States
(12) Patent Application Publication
(10) Pub. No.: US 2026/0123636 A1
(43) Pub. Date: May 7, 2026

(54) APPARATUS AND METHOD OF MANUFACTURING LASAGNA PASTA STRIPS

(71) Applicant: DEFRANCISCI MACHINE COMPANY LLC, Melbourne, FL (US)

(72) Inventors: Leonard Joseph DeFrancisci, Melbourne, FL (US); Joseph Lawrence DeFrancisci, Great Falls, MT (US); John Steven Alberga, Evergreen, CO (US); Lakshmi Narasimhon Athinarayana Venkatanarasimhan, Melbourne, FL (US)

(21) Appl. No.: 19/377,885

(22) Filed: Nov. 3, 2025

Related U.S. Application Data
(60) Provisional application No. 63/715,356, filed on Nov. 1, 2024.

(51) Int. Cl. A21C 11/16; A23L 7/109

(52) U.S. Cl. CPC A21C 11/16; A23L 7/109

(57) ABSTRACT

An apparatus and method are provided for manufacturing multiple lasagna pasta strips having rippled edges using an automated extrusion system. An extruder mixes and kneads dough and feeds it into a distribution manifold having multiple chambers, each equipped with an independently actuated valve and corresponding die inserts. The dies form lasagna strips with rippled longitudinal edges as the dough is extruded. Downstream sensors measure extrusion rate and droop distance while a vision system observes the ripple geometry. A control module including may include an AI processor configured to analyze sensor and image data to evaluate ripple amplitude, wavelength, and uniformity and automatically adjusts extrusion rate, chamber pressure, and valve position to maintain consistent shape quality. The AI module may be further configured to record historical production data and adaptively refines baseline operating parameters for subsequent runs, enabling uniform, high-throughput production of rippled-edge lasagna suitable for automated tray assembly lines.

### CROSS-REFERENCE TO RELATED APPLICATIONS

This application claims the benefit of U.S. provisional patent application 63/715,356 filed Nov. 1, 2024, which is hereby incorporated herein in its entirety.

### FIELD

The present invention relates to the field of pasta manufacturing, and, more particularly, to an having a rippled edge.

### BACKGROUND

The production of assembled lasagna entrées in the fresh and frozen ready-meal industry involves multiple sequential operations including dough preparation, sheeting, cutting, layering, filling, and packaging. In conventional production environments, lasagna noodles or pasta sheets are often handled manually during the tray assembly stage, where individual strips are positioned in a food tray and layered with sauces, cheeses, and other ingredients. This manual handling step introduces variability, increases labor cost, possible pathogen contamination from handling, and limits production throughput, particularly in large-scale commercial kitchens and industrial food manufacturing plants.

To improve efficiency and increase output, some manufacturers have implemented automated systems configured with multiple parallel production lanes. In such systems, multiple lasagna trays are assembled side-by-side as they advance along a conveyor or indexing line. Each lane corresponds to one lasagna product being assembled in parallel with others. A common approach to supplying noodles to these lanes involves a sheet-forming process in which a sheet former produces a continuous, wide sheet of pasta dough. The sheet is typically created by feeding mixed dough through one or more sets of rollers that progressively compress and stretch the dough to the desired thickness. The wide sheet is then longitudinally cut into multiple narrow strips using rotary knives or slitter assemblies, each strip corresponding to one assembly lane. This configuration enables synchronized movement of all strips, allowing multiple lasagna products to be assembled simultaneously with consistent timing and spacing.

While this method of producing multiple strips from a single wide sheet is advantageous for maintaining uniformity and speed, it has a significant limitation as the strips produced are flat along their longitudinal edges. Traditional lasagna noodles, particularly those preferred in consumer markets such as the United States, feature decorative rippled or wavy edges formed during extrusion through a die that imparts the distinctive pattern along the sides of the pasta. These ripples not only provide a recognizable aesthetic but also affect the texture, mouthfeel, and functional behavior of the pasta during cooking. The undulated edge can help retain sauce, improve adhesion between layers, and provide expansion tolerance during boiling or baking.

In contrast, sheet-formed noodles lack these structural and aesthetic characteristics. Because they are cut from a flat sheet, they have straight edges that do not expand or interlock in the same way as rippled noodles. As a result, the finished lasagna product can appear less authentic or visually appealing to consumers accustomed to traditional rippled-edge lasagna. Furthermore, the flat edge noodles can lead to less uniform layering or sauce distribution in the assembled tray, affecting both product appearance and eating quality.

Attempts to replicate rippled edges in sheet formed lasagna have proven challenging in a high throughput production environment. Techniques such as embossing, crimping, or corrugating the edges of the sheet after cutting often lead to tearing, inconsistent shapes, or loss of synchronization between adjacent strips traveling on a conveyor. Moreover, introducing additional forming or shaping operations downstream of the cutting step can complicate line integration and increase maintenance requirements.

Therefore, there exists a need for an improved lasagna production system and method capable of simultaneously forming multiple parallel lasagna strips from a continuous sheet while imparting a consistent rippled or wavy edge to each strip. Such a system should maintain precise control over strip alignment and speed across multiple lanes, integrate seamlessly into existing high-volume tray assembly lines, and preserve the visual and functional attributes of traditional rippled edge lasagna noodles.

### SUMMARY

In view of the foregoing background, it is therefore an object of the present invention to provide a method of manufacturing lasagna pasta strips having a rippled edge. The present invention provides an apparatus for manufacturing multiple lasagna pasta strips having rippled edges in a continuous, automated process. The apparatus includes an extruder configured to mix and knead dough and to deliver the dough under pressure to a distribution manifold having a plurality of chambers arranged in parallel. Each chamber communicates with a die insert mounted on a die body to form individual lasagna strips. A valve associated with each chamber independently regulates dough flow and pressure to control extrusion speed. Sensors positioned downstream of the die body monitor extrusion rate, and a vision system observes ripple geometry. A control module, which may include an artificial-intelligence (AI) processor, receives data from the sensors and vision system and adjusts valve position or extrusion speed in real time to maintain uniform extrusion rate and ripple definition across all lanes.

In another aspect, a method of manufacturing lasagna pasta strips having rippled edges is provided. The method includes pressurizing the dough using an extrusion screw or auger, and directing the dough into a distribution manifold having a plurality of chambers. Flow of dough into each chamber is independently regulated by servo-controlled valves so that multiple strips can be formed simultaneously through corresponding die inserts. Sensors measure extrusion rate and droop distance, and a vision system captures image data of the rippled edges. An AI control module may be configured to process sensor and image data to determine ripple amplitude, wavelength, and uniformity and adjusts extrusion parameters accordingly. The method further enables adaptive learning by storing data from prior production runs to refine baseline settings for subsequent runs, providing consistent product quality and efficient operation.

In another embodiment, the invention provides a lasagna production system that integrates the extrusion apparatus with a conveyor for continuous transfer of the extruded lasagna strips to a downstream station such as a cooker or blancher. The AI control module synchronizes extrusion rate and conveyor speed based on real-time sensor feedback to maintain uniform spacing, alignment, and ripple definition of the lasagna strips throughout production. The result is an intelligent, closed-loop manufacturing process that produces authentic rippled-edge lasagna noodles with high throughput, consistent shape quality, and minimal operator intervention.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a schematic perspective view of an apparatus for manufacturing multiple lasagna strips having rippled edges and in which various aspects of the disclosure may be implemented;

FIG. 2 is a schematic perspective view with a die body removed from a manifold of the apparatus of FIG. 1;

FIG. 3 is a schematic perspective view of the apparatus for manufacturing multiple lasagna pasta strips in operation;

FIG. 4 is a schematic block diagram of a control architecture for the apparatus of FIG. 1, illustrating communication between the sensors, vision system, artificial-intelligence (AI) control module, and valve actuators; and

FIG. 5 is a schematic diagram of an adaptive-learning process employed by the AI control module, showing acquisition of process data, model training, predictive control, and refinement of baseline parameters across successive production runs.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

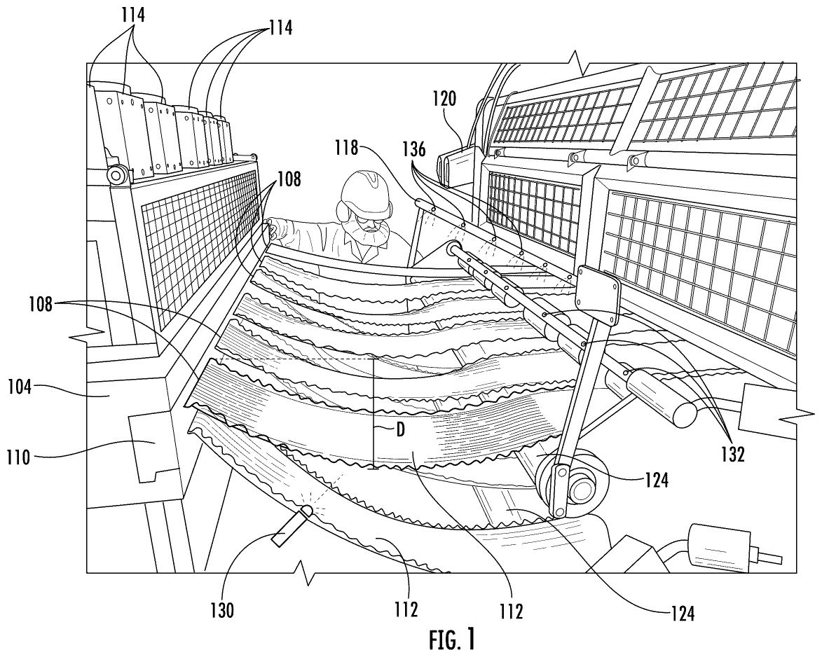

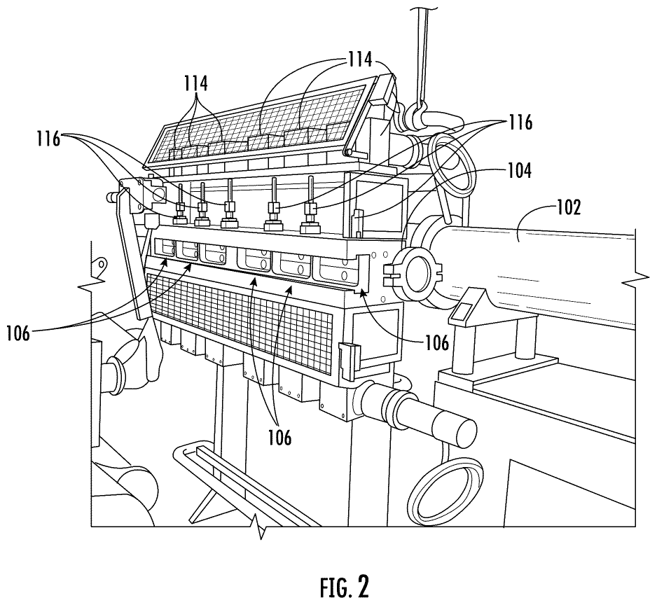

FIG. 1 illustrates a schematic view of one embodiment of an apparatus 100 for producing multiple lasagna pasta strips with rippled edges. As shown, the apparatus 100 includes a distribution manifold 104, a die body 110 having a plurality of die inserts 108. An extruder 102 (see FIG. 2) is configured to receive raw ingredients such as semolina flour and water through one or more inlets. Within the chamber, an extrusion screw, driven by a variable-speed motor, kneads the dough and builds pressure toward an outlet connected to the distribution manifold 104. The screw profile and rotational speed are optimized to ensure homogeneous mixing, consistent temperature, and uniform dough rheology. The motor may be servo-controlled to respond dynamically to signals from a control module 120, enabling fine adjustment of torque and rotational speed in response to dough feedback parameters such as pressure, temperature, or viscosity.

The distribution manifold 104 is mounted downstream of the extruder outlet. The manifold divides the dough flow into multiple channels or chambers 106 (see FIG. 2), each feeding a corresponding die insert 108 on the die body 110. The manifold 104 may include an internal plenum and a set of flow dividers that evenly distribute dough pressure among all chambers. Each chamber 106 contains a valve assembly 114 driven by an actuator 119, such as a servo or stepper motor. The actuator 119 modulates the respective valves 121 to throttle the flow of dough into its respective chamber. The position of each valve 121 may be monitored by the actuator itself 119 or have a sensor that provides real-time feedback to the control module 120, enabling independent and synchronized control of each extrusion lane. In another aspect, a low friction valve with a pneumatic motor and positioner may be implemented in lieu of a servo or stepper motor.

The die body 110 contains the die inserts 108 arranged in parallel alignment. The die inserts 108 include a plurality of forming orifices having a profile configured to impart the desired rippled contour to the longitudinal edges of the pasta strip. The die body 110 may be removably attached to the manifold 104 by sliding into a respective groove or slot, or by sanitary clamps or bolts to facilitate cleaning and interchangeability for different pasta formats. The orifices of the die inserts 108 may be precision-machined or fabricated by electrical discharge machining (EDM) to achieve smooth, consistent ripple geometry. Cooling channels may optionally run through the die body 110 to regulate temperature at the extrusion interface and prevent sticking or over-softening of the dough.

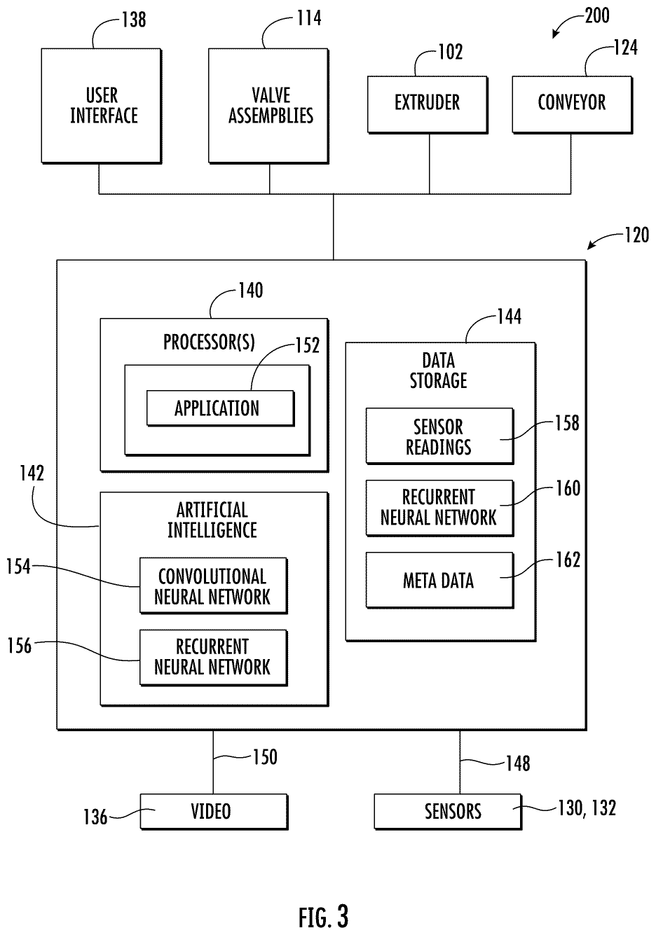

Downstream of the die body 110, the extruded pasta strips 112 descend through a free-span region before contacting the conveyor 124 as best shown in FIG. 3. This span allows the formation of a droop D, which reflects the linear velocity of the extruded dough ribbon. Sensors 130 are strategically positioned along this region to measure droop D and detect any deviation from a reference value. In one embodiment, the sensors 130 include laser displacement devices that continuously measure the vertical distance between the die exit plane and the lowest point of each strip. In another embodiment, radar-based distance sensors or machine-vision triangulation cameras may be employed for non-contact monitoring.

The vision system 118 captures images or video of the rippled edges of each lasagna strip 112. The vision system 118 may include one or more high-resolution cameras 136 equipped with controlled illumination sources, such as LED light bars, to ensure consistent imaging regardless of ambient lighting conditions. The captured images are transmitted to the control module 120, which may be configured to execute trained neural-network models to evaluate the ripple amplitude, wavelength, and symmetry along the strip. The vision system 118 can operate continuously in real time or intermittently at selected intervals depending on line speed and computing capacity.

The control module 120, which may include an embedded processor or external industrial computer, receives input data from the sensors 130, temperature 117 and pressure sensors 123, and the vision system 118. An AI module may be configured to execute algorithms trained using machine-learning techniques, such as convolutional neural networks (CNNs) or recurrent neural networks (RNNs), to correlate process conditions with ripple quality. The AI module may be configured to analyze image features and extrusion parameters to determine whether each strip meets the desired ripple specification. If deviations are detected, the module sends command signals to the valve assemblies 114 or to the extruder motor to adjust pressure, screw speed, or valve openings, thereby correcting the ripple formation in real time.

The control module 120 also includes a data-logging subsystem that stores historical production data, including valve positions, extrusion rates, dough temperature, and ripple quality metrics for each run. Prior to a new production cycle, the control module 120 uses this data to compute average baseline parameters such as throttle settings, screw speeds, and chamber pressures from a defined number of previous runs (for example, the past five). These baseline values serve as initial operating setpoints for the new cycle. During startup, the control module 120 refines these setpoints based on immediate sensor feedback, effectively self-tuning the system before full-rate production begins. Over time, the control module refines its predictive models, enabling pre-emptive correction of process drift rather than purely reactive control.

The conveyor speed is also synchronized with the extrusion rate to minimize tension and prevent deformation of the rippled edges. Position sensors 132 may detect lateral alignment of each strip to maintain even spacing across lanes. Downstream of the conveyor 124, additional processing equipment such as pre-cookers, dryers, or automated tray loaders may be integrated as part of a continuous production line.

The apparatus 100 thus integrates mechanical extrusion components with advanced sensor feedback and artificial-intelligence-based control. The combination enables continuous real-time monitoring, self-optimization, and consistent production of rippled-edge lasagna pasta strips at high throughput. The modular architecture allows scaling to any desired number of lanes, while maintaining uniform extrusion speed and ripple definition across all dies.

Referring now to FIG. 2, a perspective view of the apparatus 100 with the die body 110 removed is depicted. As shown, dough from the extruder 102 enters a primary inlet of the manifold 104 and is distributed through a plenum that divides into a series of chambers 106. Each chamber 106 extends within the manifold 104 and terminates at a discharge point aligned with a corresponding die insert 108 of the die body 110. The manifold 104 may be machined from a solid stainless-steel block and include internal channels designed to maintain equal flow length and resistance among all chambers to promote balanced dough pressure distribution. Flow diverters or baffles may be provided within the plenum to reduce turbulence and stagnation zones.

Each chamber 106 is coupled to a valve assembly 114 that independently regulates the flow of dough. The valve assembly 114 may include a servo-motor actuator 119 mounted externally. The servo motor 119 may be configured to operate a valve 121 via leadscrew or rotary cam that is configured to throttle the dough passage. A valve position sensor 116, such as an encoder or linear potentiometer, may be configured to continuously report the position of a respective valve 121 to the control module 120. This configuration allows precise control of dough pressure in each chamber 106, enabling the extrusion rate of each lasagna strip to be modulated independently without mechanical coupling between lanes.

Temperature sensors 117 and pressure transducers 123 may also be in communication with each chamber 106 to provide continuous measurement of dough conditions. The control module 120 may be configured to use these readings in combination with visual feedback to predict dough behavior and adjust flow preemptively. For example, if temperature or pressure trends indicate impending over-pressurization or dough over-hydration, the control module 120 may transmit a signal to the respective actuators 119 to slightly open selected valve 121 to maintain consistent extrusion.

The die body 110 may be slid in a groove or slot of the manifold 104 or fastened to the front face of the manifold 104 using sanitary clamps or threaded retainers, enabling tool-free disassembly. Each die insert 108 includes a passageway leading to an outlet orifice shaped to form the rippled edges along the lasagna strip. The die passages may incorporate internal flow-conditioning grooves that help orient dough strands before final shaping. Cooling or heating channels may circulate water or glycol to regulate the die temperature, thereby ensuring uniform extrusion viscosity across all lanes.

In some embodiments, a gasket or compression seal is disposed between the manifold 104 and die body 110 to prevent leakage of dough and maintain hygienic sealing. Quick-disconnect couplings for electrical and pneumatic connections permit rapid removal of the entire die assembly for cleaning or replacement, minimizing downtime in continuous production environments.

FIG. 3 demonstrates how the manifold architecture ensures equal pressure and consistent flow paths, a prerequisite for synchronizing multiple extrusion lanes. The combination of servo-controlled valves 121, temperature 117 and pressure sensors 123, and control module 120 coordination provides stable operation and compensates automatically for process variations such as dough viscosity or temperature drift.

After exiting the respective die insert 108, each lasagna strip 112 extends horizontally for a short distance before descending through a free span toward the conveyor 124 as shown in FIG. 3. As explained above, the lowest point of this droop is designated D. The magnitude of D varies with extrusion rate, dough viscosity, and strip tension, and therefore serves as an indirect indicator of flow velocity.

In one embodiment, each lane includes a dedicated laser displacement sensor 130, for example, directed downward toward the strip surface. The sensor 130 emits a beam that reflects off the lasagna strip 112 and returns to a receiver, allowing the control module 120 to calculate the distance between the die exit plane and the lowest point of the droop. The control module 120 converts this distance to an extrusion-speed parameter by applying a calibration function derived empirically during system setup. In another embodiment, the sensor 130 may be configured to determine the speed of the pasta strip 112 moving in each lane and correlate that speed to an amount of droop where the speed of the conveyor 124 is constant. For example, a higher speed of the pasta strip 112 correlates to more droop, and a slower speed correlates to less droop. In addition, radar-based distance sensor or ultrasonic sensor may perform the same function in high-moisture or steam environments where optical sensors may be less effective.

A vision system 118 may include one or more cameras 136 positioned to view the side profile and edge contour of each lasagna strip 112. Each camera 136 may include an adjustable lens and a diffused illumination source to enhance contrast along the rippled edges. The vision system 118 may be configured to capture continuous image frames that are processed by the control module 120 to evaluate the amplitude A, wavelength λ, and symmetry S of the ripple pattern. These features are extracted through image-processing techniques such as edge detection and Fourier analysis, and compared against target reference values stored in a quality database.

When deviations from desired ripple geometry are detected such as flattening or stretching of the wave pattern, the control module 120 computes corrective adjustments. These may include modifying the valve position for the corresponding chamber 106 or adjusting the screw speed of the extruder 102. The control module 120 may include AI that employs reinforcement learning or predictive control algorithms to determine the magnitude and direction of each correction, ensuring smooth compensation without inducing oscillations in the extrusion rate. The response time may be on the order of milliseconds to seconds, enabling near-instantaneous adaptation to process fluctuations.

In some embodiments, the vision system 118 further integrates a thermal camera that monitors surface temperature of the extruded dough. The AI may be configured to correlate temperature variations with changes in ripple formation to detect potential over-heating or over-hydration of the dough exiting the die. These data allow the system to adjust die cooling or manifold temperature controls automatically, maintaining consistent dough properties at the extrusion interface.

The combined measurements from the sensors 130 and vision system 118 may be fused within the control module 120, which performs multi-sensor data integration. The module 120 applies weighting algorithms that prioritize certain inputs depending on environmental conditions, for example, relying more heavily on radar measurements in humid conditions or on optical vision metrics in dry conditions. The fused data are then compared against predictive models that represent optimal extrusion behavior. Deviations beyond a set threshold trigger automatic parameter adjustments or operator alerts via a user interface 138.

As illustrated in FIG. 3, the droop-measurement sensors 130 and vision system 118 operate in conjunction to provide real-time feedback on both extrusion dynamics and noodle geometry. The control module 120 continuously interprets these inputs to maintain stable flow, precise ripple definition, and uniform strip alignment across all lanes. This integration of optical, mechanical, and AI control technologies distinguishes the present system from conventional fixed speed extrusion equipment and enables consistent high volume production of aesthetically and structurally uniform rippled edge lasagna noodles.

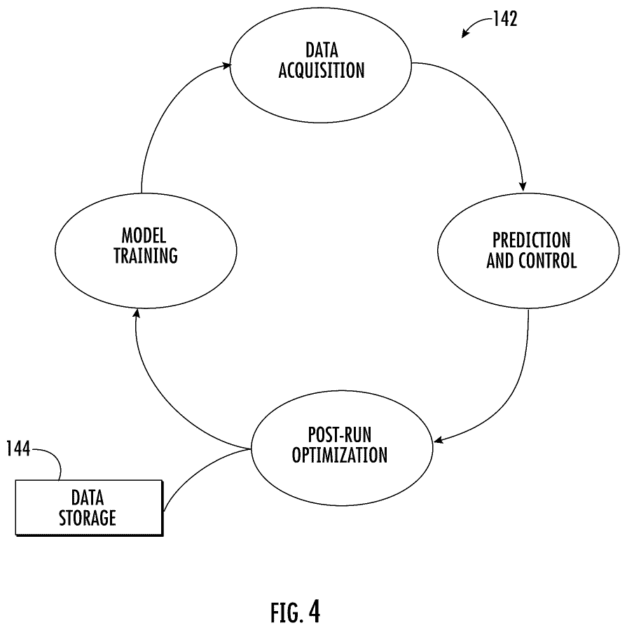

Referring now to FIG. 4, one embodiment of the control module 120 architecture 200 used in the apparatus 100 is depicted. The control module 120 includes an application 152, a processor 140, an artificial-intelligence (AI) control module 142, a data-storage unit 144, and a user interface 138 for operator interaction.

Each sensor 130 positioned downstream of the die body 110 may be communicatively coupled to the control module 120 through high-speed data lines 148. The sensors 130 provide continuous streams of numerical data representing extrusion speed, droop distance, temperature, and pressure, for example. The vision system 118 may be configured to transmit digital image frames and thermal maps through a dedicated video interface 150. The processor 140 is configured to perform initial signal conditioning, time-stamping, and synchronization so that all process data are temporally aligned for analysis by the AI module 142.

The AI module 142 receives this synchronized dataset and may be configured to execute one or more trained machine-learning models that predict optimal extrusion parameters. In one embodiment, the AI module 142 includes a convolutional neural network (CNN) 154 trained to evaluate visual features of the rippled edge, and a recurrent neural network (RNN) 156 that analyzes temporal sequences of extrusion data such as valve position, torque, and droop variation. The outputs of these models are combined in a decision-fusion layer, which generates real-time corrective signals for the valve assemblies 114. The corrections are transmitted back to the processor 140 via a deterministic communication bus ensuring response times on the order of milliseconds.

The AI module 142 may be further configured for adaptive learning. During operation, it continuously updates internal weight parameters based on comparison between predicted and observed results. If a commanded valve adjustment fails to correct a deviation in ripple formation, the AI modifies its internal model to improve prediction accuracy for subsequent runs. This self-learning feature enables the control system to adapt to changes in dough formulation, humidity, or ingredient variability without manual retuning.

A data storage unit 144 archives process variables, sensor readings 158, and image data 160 for each production cycle. The AI module 142 may be configured to reference this historical database when initializing a new run, computing baseline settings for screw speed, manifold pressure, and individual valve positions. The data storage unit 144 may also store meta-data 162 describing environmental conditions such as room temperature or flour lot number, allowing the AI module 142 to correlate external factors with product quality. This cumulative dataset supports continuous improvement and traceability.

The user interface 138 provides a graphical user interface accessible through a touchscreen or remote terminal. Operators can monitor real-time status of each extrusion lane, visualize ripple-quality metrics derived from the vision system 118, and override or fine-tune parameters if needed. The user interface 138 also displays trend graphs, predictive maintenance alerts, and quality-assurance reports generated by the AI module 142. Access control and audit logging may be implemented to maintain food-safety compliance.

As shown in FIG. 4, the system 100 thus forms a closed feedback loop extending from the mechanical extrusion hardware through the sensors array, AI analysis layer, and actuator network. The integration of machine-learning algorithms with conventional processor provides predictive, adaptive regulation of extrusion speed and ripple formation, resulting in stable, repeatable production performance with minimal human intervention.

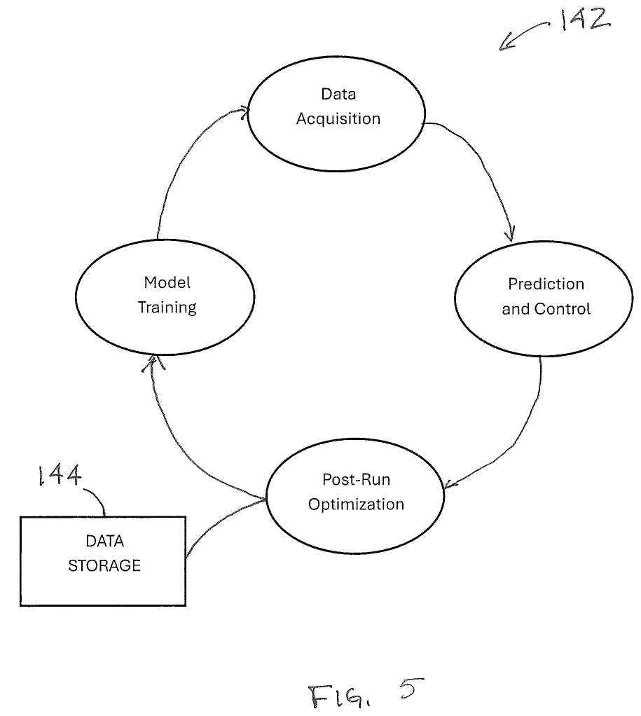

FIG. 5 depicts a schematic representation of the adaptive-learning process employed by the AI control module 142 across successive production runs. The process may be described in four stages that include data acquisition, model training, prediction and control, and post-run optimization.

During the data-acquisition stage, sensor and image data are continuously recorded during an active production cycle. The dataset includes extrusion pressures, valve positions, screw torque, dough temperature, droop distance, ripple geometry parameters, and any corrective adjustments performed. Each data record is time-aligned and tagged with a quality rating generated from the vision system 118 or from downstream inspection results.

In the model-training stage, the AI module 142 uses the stored data to refine its neural-network parameters. Training may occur locally during idle periods or on a cloud-connected analytics server for higher computational efficiency. The system identifies relationships between operating conditions and ripple-quality outcomes, adjusting internal weight coefficients to minimize prediction error.

During the prediction and control stage, which corresponds to live production, the AI module 142 applies the trained models to incoming sensor data to predict future deviations before they occur. For instance, if the model detects a pattern of increasing droop amplitude that historically leads to flattened ripples, it pre-emptively reduces the extrusion rate or opens a selected valve 121. The AI thus operates not merely as a reactive controller but as a predictive regulator capable of anticipating changes in dough behavior several seconds ahead of time.

In the post-run optimization stage, after completion of a batch, the AI module 142 computes average performance metrics for each lane such as mean valve setting, ripple uniformity index, and variance of droop distance. These averages form a baseline parameter set that becomes the starting configuration for the next production run. The AI compares each new run's performance to prior baselines and gradually refines its initialization algorithm to shorten startup stabilization time. Over multiple iterations, the model converges toward an optimized steady-state configuration tailored to the specific plant environment, dough formulation, and extruder characteristics.

FIG. 5 thereby illustrates how the system “learns” from its own operating history, continually improving both product consistency and energy efficiency. This cumulative intelligence distinguishes the invention from conventional fixed-parameter extrusion systems by enabling autonomous self-calibration and long-term process optimization.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An apparatus for manufacturing lasagna pasta strips having a rippled edge, comprising:
an extruder configured to mix water and semolina flour to form a dough and to knead the dough using an extrusion screw or auger;
a distribution manifold coupled to the extruder and comprising a plurality of chambers arranged in parallel;
a die body attached to the distribution manifold, the die body comprising a plurality of die inserts each aligned with a corresponding chamber, each die insert having an orifice configured to form a lasagna pasta strip having rippled longitudinal edges;
a valve coupled to each chamber and configured to regulate flow of the dough entering the respective chamber; and
a control module in communication with the valves and one or more sensors positioned downstream of the die body, the control module being configured to adjust the valves to maintain substantially uniform extrusion rates for the lasagna pasta strips.

2. The apparatus of claim 1, wherein each valve is driven by a servo or stepper motor to independently regulate pressure and flow rate through the corresponding chamber.

3. The apparatus of claim 1, wherein each die insert includes outer edge regions shaped to allow the dough to pass at a higher velocity than through a central portion of the die, thereby forming the rippled edge.

4. The apparatus of claim 1, wherein the sensors measure a droop distance of each lasagna pasta strip between the die body and a conveyor using a laser, radar, or optical displacement device.

5. The apparatus of claim 4, wherein the control module adjusts the valve positions based on the measured droop distance to synchronize extrusion speed among the plurality of lasagna pasta strips.

6. The apparatus of claim 1, further comprising a vision system positioned to capture images of the rippled edges of the lasagna pasta strips and transmit image data to the control module.

7. The apparatus of claim 6, wherein the control module comprises an artificial-intelligence (AI) processor trained to evaluate ripple amplitude, wavelength, and uniformity from the image data and to modify extrusion rate, valve position, or chamber pressure to maintain a desired ripple quality.

8. The apparatus of claim 7, wherein the AI processor records process parameters from prior production runs and computes averaged baseline valve settings for initializing subsequent runs.

9. The apparatus of claim 8, wherein the AI processor refines the baseline parameters using real-time feedback from the sensors during startup to achieve steady-state operation in reduced time.

10. The apparatus of claim 1, further comprising a conveyor positioned beneath the die body to receive the lasagna pasta strips in parallel lanes and to transport the strips to a downstream processing station selected from a cooker, blancher, or robotic tray-loading assembly.

11. A method of manufacturing lasagna pasta strips having a rippled edge, comprising:
mixing water and semolina flour in an extruder to form a dough;
kneading the dough with an extrusion screw or auger and forcing the dough into a distribution manifold having a plurality of chambers;
regulating flow of the dough into each chamber using independently actuated valves;
pressurizing the dough through a plurality of die inserts attached to the manifold to form multiple lasagna pasta strips having rippled edges; and
monitoring extrusion rate and ripple quality using sensors and a vision system and adjusting at least one valve based on feedback to maintain a desired ripple profile.

12. The method of claim 11, wherein monitoring extrusion rate comprises measuring a catenary droop distance of each lasagna pasta strip between the die outlet and a conveyor.

13. The method of claim 11, wherein the vision system captures image data of the rippled edges and the image data are analyzed by an AI control module trained to determine ripple amplitude, wavelength, and uniformity.

14. The method of claim 13, wherein the AI control module correlates droop-distance data with ripple geometry and adjusts extrusion pressure or screw speed to maintain consistent ripple formation.

15. The method of claim 13, further comprising storing valve and sensor data from prior runs and computing averaged baseline parameters for a subsequent run.

16. The method of claim 15, wherein the AI control module refines the averaged baseline parameters using real-time sensor feedback to minimize startup stabilization time.

17. A lasagna production system comprising:
an extrusion apparatus according to claim 1 configured to form multiple lasagna pasta strips having rippled edges;
a conveyor positioned to receive the lasagna pasta strips from the extrusion apparatus and transport them to a downstream processing station; and
an artificial-intelligence (AI) control module in communication with the extrusion apparatus and the conveyor, the AI control module being configured to synchronize extrusion rate and conveyor speed based on real-time sensor and image feedback to maintain consistent spacing and ripple formation of the lasagna pasta strips.

18. The system of claim 17, wherein the AI control module predicts process drift using a trained neural-network model and automatically adjusts at least one of extrusion rate, chamber pressure, or conveyor speed to prevent deviation from a desired ripple profile.

19. The system of claim 17, wherein the AI control module compiles quality metrics including ripple amplitude, wavelength, and uniformity and generates maintenance or calibration alerts when performance thresholds are exceeded.

20. The system of claim 17, wherein the AI control module stores production data from prior runs and computes optimized baseline parameters for subsequent runs to improve startup stability and product uniformity.
